(19) United States
(12) Patent Application Publication
(10) Pub. No.: US 2006/0031559 A1
(43) Pub. Date: Feb. 9, 2006

(54) Real Time Streaming Protocol (RTSP) proxy system and method for its use

(76) Inventors: Gennady Sorokopud, Netanya (IL); Aharon Satt, Haifa (IL); Liron Langer, Haifa (IL)

Correspondence Address: POLSINELLI SHALTON WELTE SUELTHAUS P.C., 700 W. 47TH STREET, SUITE 1000, KANSAS CITY, MO, 64112-1802, US

(21) Appl. No.: 10/852,995

(22) Filed: May 25, 2004

(51) Int. Cl. G06F 15/16

(52) U.S. Cl. 709/232

(57) ABSTRACT

Systems and methods exercise control over the Real Time Streaming Protocol (RTSP) messages in order to control the underlying streaming services. The methods and systems also minimize bandwidth allocated for each streaming flow. The systems and methods control streaming services by analyzing the RTSP associated with a particular streaming service.

### TECHNICAL FIELD

The present invention is directed to Real Time Streaming Protocols (RTSPs). In particular, the present invention is directed to utilizing Real Time Streaming Protocol (RTSP) to control the packet flows associated with streaming services between streaming providers and streaming clients.

### BACKGROUND OF THE INVENTION

Streaming services are becoming increasingly commnonplace. For example, a cellular telephone user may desire streaming services in the form of a video clip, sound clip, e.g., a song, or the like delivered to a streaming client installed on his cellular telephone or the like. By providing these streaming services, operators can increase their revenue as they can charge for content on a per-stream basis.

Streaming services are built on top of a streaming framework. A typical streaming framework includes a streaming server and a streaming client (installed on, for example, a cellular telephone, Personal digital assistant (PDA) or other similar communication apparatus), which communicate with each other through a control protocol, and a streaming protocol, over single or multiple channels.

Streaming services allow users to experience media browsing, for example, watching video clips or listening to sound clips, in real-time. Moreover these streaming services are time sensitive, and allow for tight time synchronization between different media types, for example, video and audio are synchronized in the same clip.

Streaming services require sufficient bandwidth to transmit the requisite streams that must remain constant during the lifetime of the streaming session. For example, absent constant sufficient bandwidth to deliver the desired streaming flow, high jitter and high delay, in any combination, the Quality of Service (QoS) associated with the streaming flow may degrade to unacceptable levels. The level of bandwidth required to be sufficient depends on factors such as: 1) encoding used during creation of the streaming content; and 2) the type of streaming protocol used to deliver this content.

In addition, almost all instances where QoS degrades results in a significant decline in Quality of Experience (QoE), for the streaming user. QoE is based on human perception, and a decline in QoE typically includes audible and visible delays and distortions.

From a system and network standpoint, streaming services consume excessive bandwidth. In particular these streaming services take more bandwidth than other types of services, such as those belonging to the classes of background, interactive, streaming and conversational, these four classes as defined in 3^{rd} Generation Partnership Project: Technical Specification Group Services and System Aspects; Quality of Service (QoS) concept and architecture (Release 1999), 3GPP TS 23.107, V.3.9.0 (2002-09), 3GPP Organizational Partners, Valbonne, France© 2002, this document incorporated by reference herein. Such excessive consumption of bandwidth, coupled with degraded QoE, wastes network resources, which, in cases of wireless or cellular networks, are scarce and expensive.

One proposed solution to improve QoS and QoE has been to use the streaming client to measure network conditions (for example, bandwidth, jitter and cumulative packet loss), and report these conditions to the streaming server. Additionally, the streaming server and the streaming client sit on opposite edges of a network. The streaming server receives the report of conditions from the streaming client and changes the streaming flows in order to adjust them to reported network conditions. This change typically included rate adaptation.

As a result of this positioning, the streaming client can not accurately estimate the network conditions inside the network. Any estimate from the streaming client is not representative of current network conditions, and is therefore, inaccurate.

Most existing streaming servers employ different kinds of rate estimation algorithms, which are based on reports received from the streaming clients. These algorithms are mostly proprietary (but can be based on standard protocols, like Real Time Control Protocol (RTCP)), as defined in, H. Schulzrinne, et al., Request for Comments (RFC): 1889, RTP: A Transport Protocol For Real-Time Applications, Network Working Group, January 1996 (RFC 1889), this document incorporated by reference herein, and utilize data sent by the streaming client on a frequent basis, in order to estimate the network conditions.

Interpretation and measurement methods for each parameter may vary between different algorithms. In the end, all the measurements collected, affect the server's decision on encoding rates (in case when multiple encoding rates are supported) for the various streams. Most streaming solutions encode each piece of content with different coding schemes at the same time, ranging from a few kilobits per second up to 30-40 kilobits per second. The streaming server would than make an appropriate decision as to the rate of the streaming flows. This decision is typically incorrect, because it fails to use specific data from the network, whereby it negatively impacts QoS and QoE. Moreover, it is not enough to adjust the streaming rate to the network conditions, as network conditions must be adjusted to the streaming rate, by actively intervening into the traffic flow in the network.

Another proposed solution utilized a traffic shaper in order to allocate sufficient resources for the streaming services. By using only a traffic shaper, essential functions, such as traffic classification, drop and admission control, and resource reservation, were impaired. The classification could not be sufficiently effective because most contemporary streaming services can not be easily classified with simple traffic classification mechanisms based on Layer 3 and Layer 4, and frequently require Layers 5-7 classification and state-full packet inspection (the Layers in accordance with Open Systems Interconnection (OSI) Reference Model-International Organization of Standards (ISO) Recommendation X.200 of the International Telephony Union (ITU)-TS), and in some cases, even these methods would not be sufficient. The admission and drop control mechanism functionality terminates or suspends a streaming flow, as streaming protocols do not provide the means to do so. Resource reservation components would not receive the precise information describing potential streaming resource consumption, as this information is not encoded in the headers of the commonly used streaming protocols.

In summary, a substantial portion of QoS and QoE degradation in streaming services can be attributed to network performance (like packet loss or drop). In addition to inadequate network performance, incorrect estimation of the network conditions by the streaming client or the streaming server, and excessive rate switching, can also cause QoS and QoE degradation. Also, contemporary networks lack mechanisms to pre-allocate and maintain the resources required by each streaming flow on real-time basis. Additionally, these contemporary networks lack any mechanism for streaming admission and drop control, which is extremely important as well, since it improves the QoE and reduces waste of network resources.

Streaming services utilize a number of protocols, typically a control protocol and a streaming protocol. A commonly utilized control protocol is Real Time Streaming Protocol (RTSP), while a commonly used streaming protocol is Real Time Transport Protocol (RTP). RTSP normally uses Session Description Protocol (SDP) to transfer information related to multimedia sessions and content.

The Real Time Streaming Protocol, or RTSP, is an application-level protocol for control over the delivery of data with real-time properties. RTSP provides an extensible framework to enable controlled, on-demand delivery of real-time data, such as audio and video. Sources of data can include both live data feeds and stored clips. This protocol is intended to control multiple data delivery sessions, provide a means for choosing delivery channels such as UDP, multicast User Datagram Protocol (UDP) and Transport Control Protocol (TCP), and provide a means for choosing delivery mechanisms based upon various streaming protocols, such as RTP (as defined in RFC 1889).

RTP provides end-to-end network transport functions suitable for applications transmitting real-time data, such as audio, video or simulation data, over multicast or unicast network services. RTP does not address resource reservation and does not guarantee QoS for real-time services.

Session Description Protocol (SDP) is intended for describing multimedia sessions for the purposes of session announcement, session invitation, and other forms of multimedia session initiation. The protocol is fully described in, M. Handley, et al., Request For Comments: 2327, SDP: Session Description Protocol, Network Working Group, April 1998 (RFC 2327), this document incorporated by reference herein. SDP is used to convey information about media streams in multimedia sessions to allow the recipients of a session description to participate in the session. SDP is primarily intended for use in an inter-network, although it is sufficiently general that it can describe conferences in other network environments. SDP is not used on its own, but with Session Announcement Protocol (SAP) or with Session Initiation Protocol (SIP) or RTSP. The SIP/SDP combination has been adopted by 3^{rd} Generation Partnership Project (3GPP) (3GPP Organizational Partners, Valbonne, France for Internet Protocol Multimedia Subsystem (IMS).

### SUMMARY OF THE INVENTION

The present invention improves on the contemporary art by providing systems and methods that exercise control over the Real Time Streaming Protocol (RTSP) messages in order to control the underlying streaming services. The present invention also provides systems and methods for controlling streaming services with high Quality of Service (QoS) and high Quality of Experience (QoE). The methods and systems of the invention minimize bandwidth allocated for each streaming flow.

The invention controls streaming services by analyzing the RTSP, associated with a particular streaming service. Typically, data received from the RTSP control message is used to characterize the potential incoming streaming flow of packets and the like. This analysis results in the streaming flow being transmitted to the streaming client with sufficient bandwidth. This analysis could also result in the streaming flow being suspended or terminated.

The invention employs an RTSP proxy, typically a server or the like, and a network QoS server. These components are typically integrated into a system, such that the system sits between the streaming client and a streaming content provider (for example, a streaming server) to control streaming services. Both the QoS engine and the RTSP proxy function as Policy Enforcement Points (PEP), with a QoS engine, additionally serving as a Policy Decision Point (PDP).

An embodiment of the invention is directed to a method for controlling streaming in a network. The method includes analyzing at least one Real Time Streaming Protocol (RTSP) message associated with at least one streaming flow, and controlling Quality of Service (QoS) levels for the at least one streaming flow based on the analyzing of the at least one RTSP message. Controlling of the Quality of Service levels for the at least one streaming flow may include admission control. This admission control may include at least one decision for allowing the at least one streaming flow to enter the network.

Another embodiment of the invention is directed to an architecture for controlling streaming in a network. The architecture includes a first component configured for analyzing at least one Real Time Streaming Protocol (RTSP) message associated with at least one streaming flow, and a second component configured for controlling Quality of Service (QoS) levels for the at least one streaming flow, based on the analyzed at least one RTSP message. The first component may be configured for intercepting and relaying the at least one RTSP message associated with the at least one streaming flow, while the second component may be configured for admission control.

Another embodiment of the invention includes a computer-usable storage medium having a computer program embodied thereon for causing a suitable programmed system to control streaming in a network by performing the following steps when such program is executed on the system. These steps include, analyzing at least one Real Time Streaming Protocol (RTSP) message associated with at least one streaming flow, and controlling Quality of Service (QoS) levels for the at least one streaming flow based on the analyzing of the at least one RTSP message. The program step of controlling the Quality of Service levels for the at least one streaming flow may include admission control for allowing the at least one streaming flow to enter the network, and may include classifying the at least one streaming flow based on the data from the analysis of the at least one RTSP message by categorizing incoming flows of packets of the at least one streaming flow. Additionally, the step of controlling the Quality of Service levels for the at least one streaming flow may include drop control.

Another embodiment of the invention is directed to a system for controlling streaming in a network. The system includes a Real Time Streaming Protocol (RTSP) proxy server configured for intercepting and relaying at least one RTSP message and analyzing the at least one RTSP message, and a second server in communication with the RTSP proxy server, the second server configured for controlling Quality of Service (QoS) levels for at least one streaming flow, based on the analyzing of the at least one RTSP message. The RTSP proxy server may include means for parsing the at least one RTSP message into at least RTSP and Session Description Protocol (SDP) headers, extracting content from at least one of the parsed headers and compiling a bandwidth profile from at least one of the parsed headers. The second server may include a Quality of Service (QoS) server. This QoS server may be configured for controlling QoS levels, and may include components for admission control of the at least one streaming flow.

Another embodiment of the invention includes a system for controlling streaming in a network. The system includes means for intercepting at least one Real Time Streaming Protocol (RTSP) message, means for relaying at least one RTSP message, means for analyzing for at least one RTSP message, and means for controlling Quality of Service (QoS) levels for at least one streaming flow associated with the means for analyzing the at least one RTSP message.

Another embodiment of the invention is directed to an apparatus for controlling streaming in a network. The apparatus includes means for obtaining at least one Real Time Streaming Protocol (RTSP) message from at least one streaming flow, means for relaying the at least one RTSP message, means for analyzing the least one RTSP message, and means for providing data corresponding to the analysis of the at least one RTSP message to at least one device for controlling Quality of Service (QoS) levels for the at least one streaming flow. The means for obtaining the at least one RTSP message from the at least one streaming flow may include means for intercepting the at least one RTSP message.

Still another embodiment of the invention is directed to a computer-usable storage medium having a computer program embodied thereon for causing a suitable programmed system to control streaming in a network by performing the following steps when such program is executed on the system. The program steps include, obtaining at least one Real Time Streaming Protocol (RTSP) message from at least one streaming flow, relaying the at least one RTSP message, analyzing the least one RTSP message, and providing data corresponding to the analysis of the at least one RTSP message to at least one device for controlling Quality of Service (QoS) levels for the at least one streaming flow. The step of obtaining the at least one RTSP message from the at least one streaming flow may include intercepting the at least one RTSP message.

### BRIEF DESCRIPTION OF THE DRAWINGS

Attention is now directed to the drawing figures, where like reference numerals or characters indicate corresponding or like components. In the Drawings:

FIG. 1 is a diagram of an exemplary architecture in accordance with an embodiment of the invention;

FIGS. 2A-2C form a flow diagram for the admission control process in accordance with an embodiment of the invention; and

FIG. 3 is a flow diagram for the drop control process in accordance with an embodiment of the invention.

### DETAILED DESCRIPTION

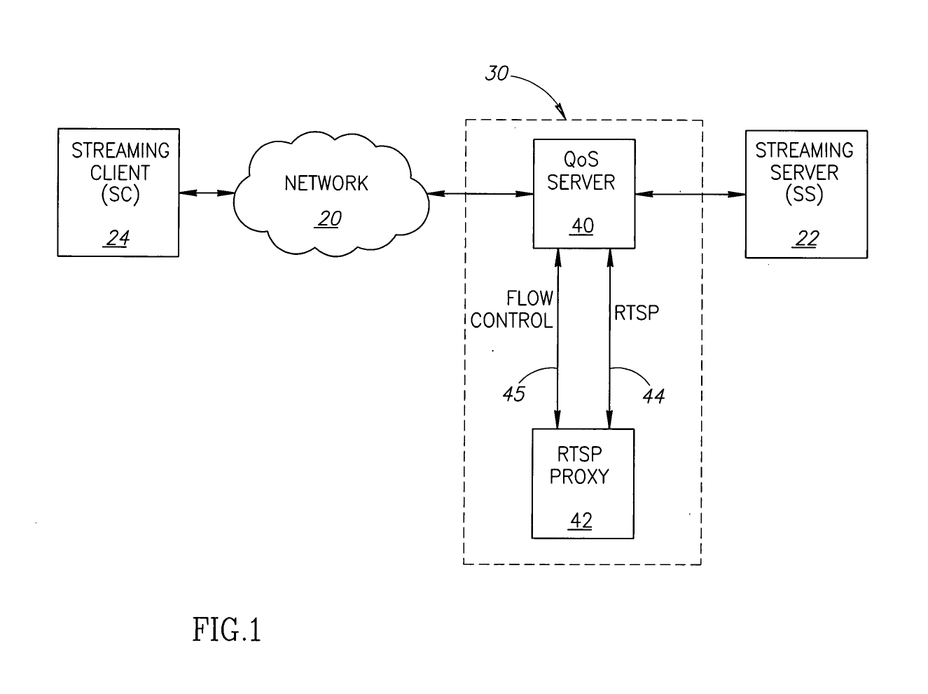

FIG. 1 shows an exemplary architecture on which the invention is employed. This architecture is centered on a network 20, for example, the Internet or any other Public Data Network (PDN). This architecture is formed of components, for example, as detailed below.

At the edges of this network 20, are a streaming server 22 and a streaming client 24. A system 30 of the invention mediates between the network 20 and the streaming server 22. This system typically includes a Quality of Service (QoS) server 40 in communication with a proxy server 42, for example, a Real Time Streaming Protocol (RTSP) proxy server. Communication between the QoS server 40 and the RTSP proxy server 42 is typically over packet based network links. Packets transferred over these packet-based network links are either: RTSP messages or portions thereof, that travel over bi-directional RTSP channel(s) 44, or control messages, for example, UDP packets, that travel over bi-directional control channel(s) 45.

The streaming server 22 is, for example, a Helix Universal Server from Real Networks of Seattle, Wash., USA. Any other commercially available streaming server that supports RTSP is suitable. While a single streaming server 22 is shown, this is for purposes of description only, as typically, there are multiple streaming servers 22.

The streaming client 24 is, for example, a RealOne Player from Real Networks of Seattle, Wash., USA. This streaming client can be downloaded and installed on a large number of different platforms including Personal digital Assistants (PDAs), cell phones, computers and the like. Any other commercially available streaming client that supports RTSP is suitable. While a single streaming client 24 is shown, this is for purposes of description only, as typically, there are multiple streaming clients 24.

In accordance with the invention, the streaming server 22 and the streaming client 24 are typically configured to utilize RTSP for streaming purposes.

The system 30 is designed to process passing traffic. This traffic includes streaming flows (for example, of packets) from streaming services and RTSP sessions. The system 30 includes the QoS server 40 and the RTSP proxy server 42, along with related hardware, software or both.

The QoS server 40 may be network specific. Additionally, this QoS server 40 is modified (with hardware, software or both) for compatibility with RTSP proxy server 42. For example, should the network 20 be a cellular network, a QoS server 40 could be a Mobile Traffic Shaper™ (MTS) from CellGlide United Kingdom. Should the network 20 be a Wide Area Network (WAN), a QoS server 40 could be a NetEnforcer from Allot Communications of Eden Prairie, Minn. The QoS server 40 is positioned, such that it controls all the traffic between the streaming server 22 and the network 20.

This QoS server 40 is, for example, typically also configured to redirect all of the RTSP traffic, in both uplink and downlink directions, to the RTSP proxy server 42. Alternately, a traffic redirector, for example a Application Switch III, available from Radware, Israel, can be used to redirect the RTSP traffic. This traffic redirector is typically an add-on component to the QoS server 40, and may also be integral with it.

The RTSP proxy server 42 includes a server component installed or embedded into a hardware platform, such as a Solaris® UNIX platform, available from Sun Microsystems of California. The server component and hardware platform should support all types of communications used by the network 20 and the streaming server 22. This RTSP proxy server 42 is configured (by various combinations of hardware, software or both) to intercept and analyze RTSP packets, including requests from the streaming client 24 and responses from the streaming server 22. For example, the aforementioned RTSP packets can be relayed on top of a TCP protocol, and use TCP port 554. The content of the RTSP packets conforms to the Real Time Streaming Protocol defined in, H. Schulzrinne, et al., Request For Comments: 2326, Real Time Streaming Protocol (RTSP), Network Working Group, April 1998 (RFC 2326), this document incorporated by reference herein.

The RTSP proxy server 42 is also configured to relay the requests and responses in the appropriate directions, while retaining the original source and destination IP addresses of the RTSP messages or portions thereof (or data corresponding to these IP addresses). By retaining these original source and destination IP addresses, the RTSP proxy server 42 is considered to be fully transparent to the streaming client 24, the streaming server 22, and the QoS server 40.

The RTSP proxy server 42 is also designed to match RTSP response(s) with RTSP request(s), to form RTSP request-response pairs (one pair at minimum). An RTSP request-response pair is one RTSP request and one RTSP response, both of which have the same CSeq header, transferred on top of the same TCP connection, and the response immediately follows the request.

All of the aforementioned servers 20, 40, 42, in addition to the components listed above, include components such, as storage media and interfacing devices, either internal thereto or associated therewith (external to), and are suitable for use with numerous hardware and/or software components.

An RTSP session will include many, but in most cases, not all of, RTSP request-response pairs, that share the same Session header, and travel from the streaming client 24 to the intended streaming server 22, in accordance with the packet IP header. However, if either or both of the RTSP request-response pair lacks a Session header, then the pair will be assigned to a particular RTSP session if its CSeq header is sequential to the CSeq header of other RTSP request-response pairs.

A streaming session associated with the particular RTSP session is a collection of packet flows that match the transport profile of this RTSP session (described below). The packet flow is considered to be a match with the transport profile of the particular RTSP session if its source IP address is identical (equal) to the Client IP address of the transport profile, and if its destination IP address is identical (equal) to the Server IP address of the transport profile. This is also true in reverse, as packet flow is bi-directional. Additional conditions for a match include the transport protocol of the packet flow (Transport Control Protocol (TCP) or User Datagran Protocol (UDP)) being identical (equal) to the Transport type of the transport profile, and the client TCP or UDP port falls within the Client Port Range of the transport profile.

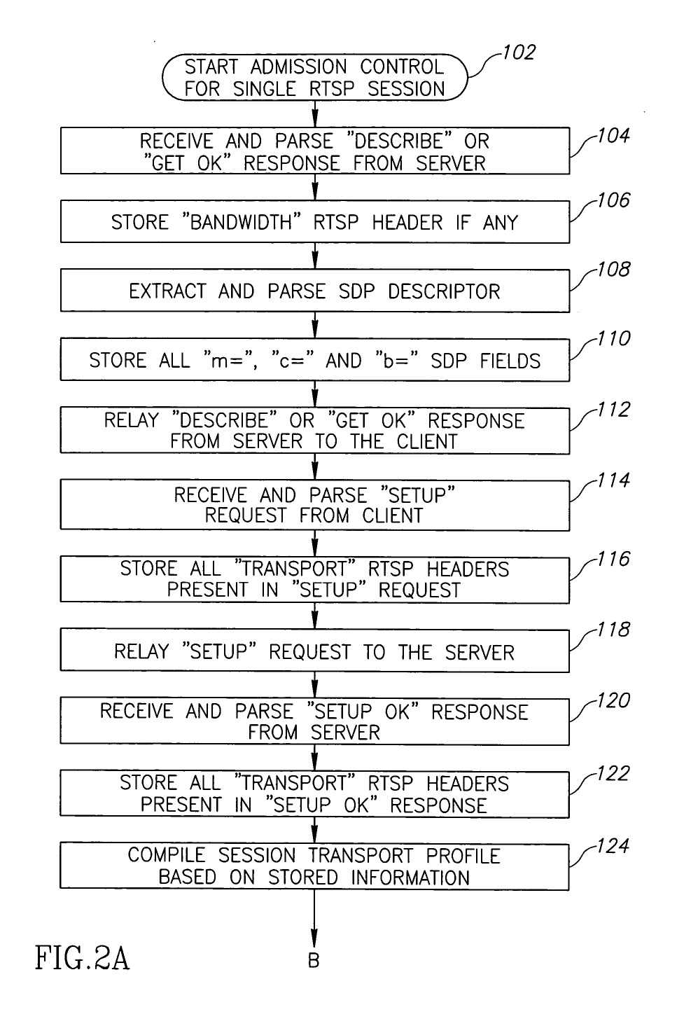

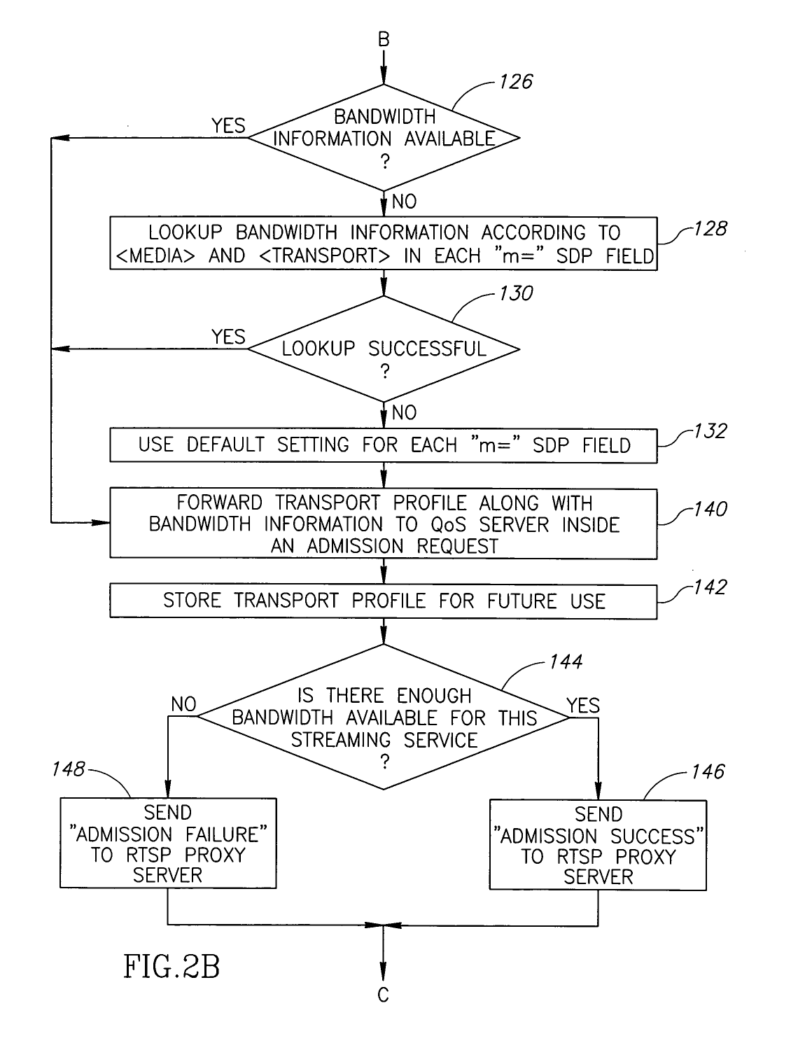

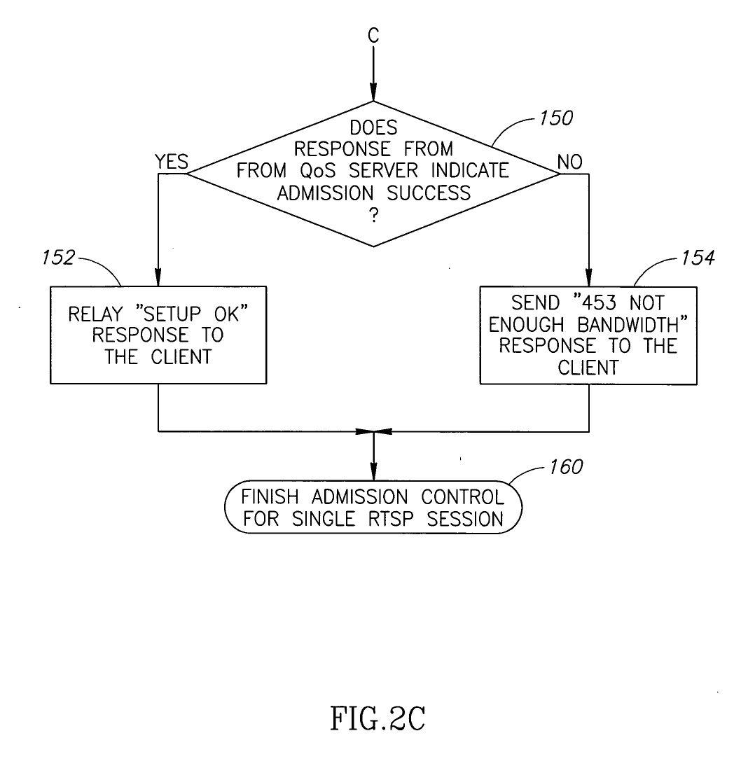

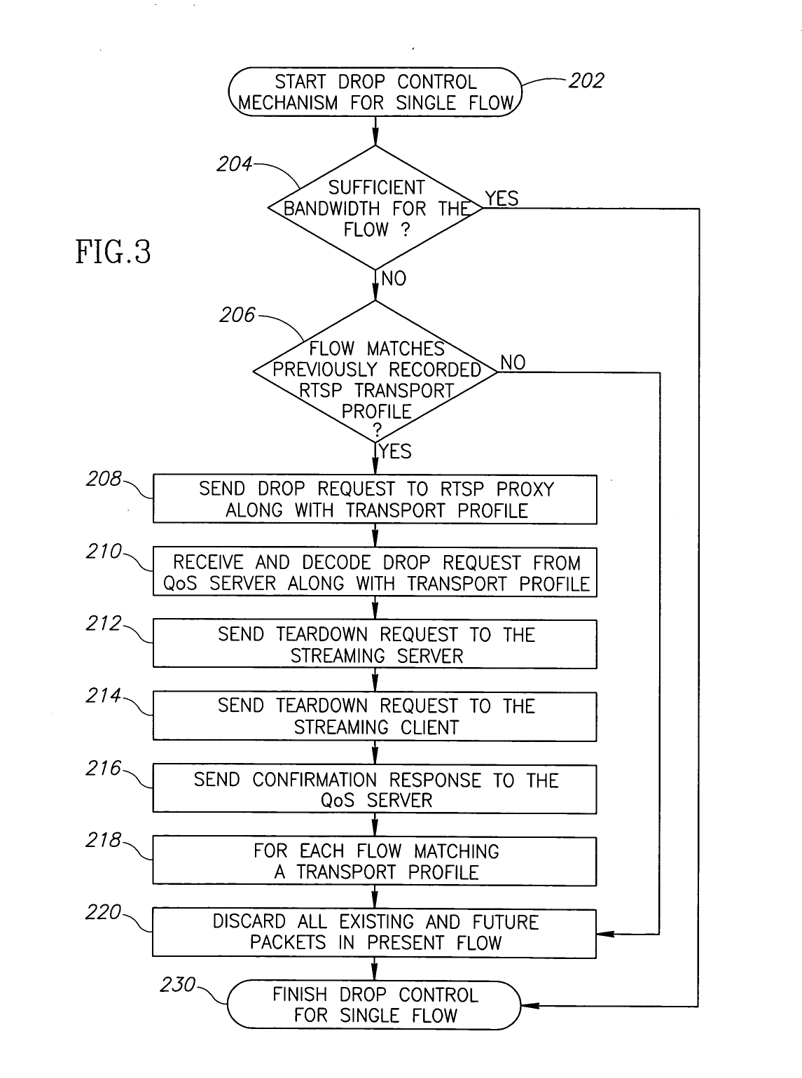

Within the system 30, the processes for admission, drop, classification and resource estimation are performed. These processes are performed by architectural components on the QoS server 40, the RTSP proxy server 42, or both. Processes for admission, drop control are now detailed, and attention is now directed also to FIGS. 2 and 3.

FIGS. 2A-2C form a flow diagram for the admission control process. This process is performed partially in both the QoS server 40 and in the RTSP proxy server 42.

The process begins, at block 102, as the RTSP proxy server 42 receives data indicating formation of the new RTSP session. Once a response for a DESCRIBE or GET request from the streaming server 22 is received, the process moves to block 104, where the response is analyzed and parsed. The parsed information is analyzed to detect if RTSP Bandwidth header is present, and if so, the value of the bandwidth header is stored in temporary allocated memory associated with a particular RTSP session, at block 106.

A Session Description Protocol (SDP) descriptor associated with the RTSP session is extracted from the parsed information, and it is parsed at block 108. At block 110 the parsed SDP descriptor information is searched for all “m=”, “c=” and “b=” fields. The “m=”, “c=” and “b=” fields are defined in RFC 2327, that is incorporated by reference herein. If found, all “m=”. “c=” and “b=” fields, along with their content, are stored in temporary allocated memory associated with a particular RTSP session. The response from block 104 is relayed to its original destination at block 112.

The process resumes upon the receipt of a SETUP request from a streaming client 24. Once a SETUP request is received, it is parsed, at block 114. The parsed information is analyzed to detect if RTSP Transport headers are present, and if so, the values of the Transport headers are stored in temporary allocated memory associated with a particular RTSP session, at block 116. The request from block 114 is relayed to its original destination at block 118.

The process resumes upon the receipt of a SETUP OK response from a streaming server 22. Once a SETUP OK response is received, it is parsed, at block 120. The parsed information is analyzed to detect if RTSP Transport headers are present, and if so the values of the Transport headers are stored in temporary allocated memory associated with a particular RTSP session, at block 122.

At block 124, a session transport profile is compiled based on portions of the information stored in the process so far for this particular RTSP session. Compilation of this transport profile (for this particular RTSP session) includes: 1) defining fields for this transport profile; 2) for each defined field, defining a number of sources for determining the value of each particular field; and 3) selecting data from the stored information corresponding to one of the defined sources.

As an example, for Table 1, listed immediately below, the sources for each field are checked in an order going from top to bottom in accordance with the above listed table. Once the information for particular field is obtained from a particular source the process moves to the next field.

TABLE 1

| Field | Source |
|---|---|
| Client IP address (formatted as defined in, | A destination field from the |
| Request For Comments (RFC): 791, Internet | Transport RTSP header as |
| Protocol, Defense Advanced Research Pro- | defined in RFC 2326 |
| jects Agency (DARPA), Arlington, VA, | A connection address field |
| Internet Program, Protocol Specification, | from the SDP “c=” header |
| Information Sciences Institute, University | as defined in RFC 2327 |
| of Southern California, Marina del Rey, CA, | A source IP address from |
| September 1981 (RFC 791)) | the RTSP request |
| | A destination IP address |
| | from the RTSP response |
| Server IP address (formatted as defined in | A source field from the |
| RFC 791) | Transport RTSP header as |
| | defined in RFC 2326 |
| | A source IP address from |
| | the RTSP request |
| | A destination IP address |
| | from the RTSP response |
| Client port range (coded as Source Port in, | A client_port field from |
| Request For Comments (RFC): 793, | the Transport RTSP header |
| Transmission Control Protocol, Defense | as defined in RFC 2326 |
| Advanced Research Projects Agency | A <port>/<number of |
| (DARPA), Arlington, VA, Internet Program, | ports> field from the SDP |
| Protocol Specification, Information Sciences | “m=” header as defined in |
| Institute, University of Southern California, | RFC 2327 |
| Marina del Rey, CA, September 1981 (RFC | |
| 793)) | |
| Transport type (0 - UDP, 1 - TCP) | A lower-transport field |
| | from the Transport RTSP |
| | header as defined in RFC |
| | 2326 |
| | A <transport> field from |
| | the SDP “m=” header |
| | as defined in RFC 2327 |
| Server port range (optional) | A server_port field from |
| | the Transport RTSP header |
| | as defined in RFC 2326 |
| RTSP session ID | A Session header from the |
| | RTSP header as defined in |
| | RFC 2326 |

Both RFC 791 and RFC 793 (listed in Table 1, above) are incorporated by reference herein.

The process moves to block 126, where the presence of bandwidth information is checked. If at least one of “b=” fields from the SDP descriptor, or RTSP Bandwidth header were collected by the process at either of blocks 106 or 110, the process moves to block 140.

At block 140 the RTSP proxy server 42 sends a compiled transport profile along with available bandwidth information to the QoS server 40. The transport profile and bandwidth information are inside an admission request.

A compiled transport profile along with available bandwidth information are sent inside a control message from the RTSP proxy server 42 to the QoS server 40. For example, this control message can be sent inside a UDP packet through the internal network connection.

If the conditions of block 126 are not met, the process moves to block 128. In block 128 the process attempts to determine the bandwidth information from the internally configured lookup table, whose values are taken from RFC 2327, a Session Description Protocol (SDP). An exemplary lookup table is presented as Table 2, as follows:

TABLE 2

| <media> field | <transport> field | Bandwidth |
|---|---|---|
| Video | RTP/AVP | 20 kilobit/second |
| Audio | RTP/AVP | 7 kilobit/second |
| Video | * | 25 kilobit/second |
| Audio | * | 10 kilobit/second |

In Table 2, all <media> and <transport> fields are defined in RFC 2326, and “*” represents any field content. Additionally, fields on the “m=” header of the SDP profile are matched against the rows of the table. If a match is determined, then bandwidth information is taken from the third column of the row that includes the match. If a match is determined at block 130, the process moves to block 140.

If a match is not determined at block 130, the process moves to block 132. For each previously accumulated “m=” SDP field the process adds a pre-configured default (default setting) bandwidth value to total bandwidth information, at block 132. The process then moves to block 140.

The process now moves to block 142 where the transport profile, that was created in block 124, is stored by the QoS server 40 for future use. The implementation of the particular QoS server 40 will dictate the storage policy. The process moves to block 144, where the QoS server 40 checks if there is enough bandwidth to accommodate the incoming streaming session. This is a built-in feature of the particular QoS server 40 that responds to bandwidth information provided from the RTSP proxy server 42, as accumulated in blocks 106, 110, 128 and 132 above. If there is sufficient bandwidth to accommodate the incoming streaming service, the process moves to block 146, where it sends a response to the RTSP proxy server 42 indicating admission success. Alternately, if there is not enough bandwidth, the process moves to block 148, where an admission failure response is sent to the RTSP proxy server 42.

Both of blocks 146 and 148 move the process to block 150, where the response from the QoS server 40 is checked by the RTSP proxy server 42 for admission success. If the admission of the streaming flow was successful, the process moves to block 152. At block 152 the SETUP OK response received from the streaming server 22, is relayed to the streaming client 24. If the admission of the aforementioned streaming flow was not successful, the process moves to block 154, where the RTSP proxy server 42 sends the streaming client 24 a “453 Not enough bandwidth” RTSP response.

Both of blocks 152 and 154 move the process to block 160 where admission control for this particular RTSP session ends. The above described process can be repeated for each incoming RTSP session.

Attention is now also directed to FIG. 3, a flow diagram detailing an exemplary process for drop or retention control (for example, of packet flows). Drop control applies to flows that have been already admitted into, or are existing in the network. Drop control typically applies in situation where resources have diminished to a point where the flow can not be maintained because its supporting bandwidth must be reallocated in accordance with the network service policies. Additionally, drop control will be used to terminate the flow of packets in addition to the bandwidth reallocation that ultimately limited packet flow.

The drop control process starts at block 202, where a particular packet flow is processed. The process moves to block 204, where availability of bandwidth for the particular packet flow is checked, typically in the QoS server 40. If bandwidth is found to be sufficient to support the flow, the process moves to block 230, where it ends. If bandwidth is insufficient, the process moves to block 206, where the QoS server 40 attempts to establish a match between the previously recorded RTSP transport profile and the packet flow.

If there is not a match, the process moves to block 220, where all existing and future packets of the particular packet flow are discarded. If there is a match, the process moves to block 208, where a drop request is sent to the RTSP proxy server 42 (from the QoS server 40). This request includes an RTSP transport profile in accordance with the transport control profile defined at block 124 of the admission control process.

At block 210, the RTSP proxy server 42 receives and decodes this drop request along with the RTSP transport profile. A TEARDOWN RTSP request is then sent from the RTSP proxy server 42 to the streaming server 22 at block 212. This request is sent in accordance with the RTSP transport profile received at block 210. A TEARDOWN RTSP request is then sent from the RTSP proxy server 42 to the streaming client 24 at block 214. This request is sent in accordance with the RTSP transport profile received at block 210.

The RTSP proxy server 42 then sends a drop confirmation response to the QoS server 40 at block 216. The process then moves to block 218/220, where for each flow matching a RTSP transport profile, the existing and future packets for this (the instant or present) flow are discarded. The process then ends at block 230, where the drop control for a particular packet flow is concluded.

The process for classification is designed to categorize incoming flows (of packets) inside a QoS server 40. The classification process, performed by the QoS server 40, includes receipt of an RTSP transport profile (as described above) from the RTSP proxy server 42, and matching this profile to the packet headers of the incoming streaming flow. Compilation of the RTSP transport profile is in accordance with block 124, as shown in FIGS. 2A-2C and described above. Matching of the RTSP transport profile to packet headers is done in accordance with block 206, as shown in FIG. 3 and described above.

Alternately, the classification process can be any other known classification process, such as those illustrated by the following three examples.

A first example involves applying service policies to different traffic classes. These classes can be, for example, Hypertext Transfer Protocol (HTTP) traffic, traffic to or from a particular server or client. The service policy can specify, for example, different resource allocation rules for all traffic belonging to the particular traffic class.

In accordance with this first example, when a flow is received by the QoS server 40, the packet headers are checked to see if they are HTTP headers. If HTTP headers are found, the flow belongs to the HTTP traffic class, and therefore a specific service policy will be applied to this flow. For example, this policy can specify that this flow will be allocated at most 10 kilobits per second (Kbps) from the total available bandwidth.

A second example involves applying a routing decision to traffic belonging to an RTSP class. When a flow is received by the QoS server 40, it is checked to represent a TCP transmission with source or destination port number equal to 554. If the source or destination port number is equal to 554, the flow is routed through (redirected to) the RTSP proxy server 42.

A third example involves classification and applying policies to the incoming streaming flows at the QoS server 40. The packets that form the streaming flows do not have easily recognizable characterizing packet headers. Accordingly, the ability of the QoS server 40 to classify these flows is limited to examination of sources and destinations for each packet, or to statistical analysis.

The process for resource estimation is designed to analyze the incoming flows (of packets) inside a QoS server 40, and estimate the potential bandwidth demand associated with the particular incoming flow. The resource estimation process, performed by the QoS server 40, includes receipt of an RTSP transport profile, and bandwidth information (as described above) from the RTSP proxy server 42, and matching this profile to the packet headers of the incoming streaming flow. Compilation of the RTSP transport profile is in accordance with block 124, as shown in FIGS. 2A-2C and described above. Determination of the bandwidth information is performed in accordance with blocks 126, 128, 130 and 132 of the admission control process, shown in FIGS. 2A-2C and described above. Matching of the RTSP transport profile to packet headers is done according with block 206, as shown in FIG. 3 and described above. If there is a match, the bandwidth information associated with a matching RTSP transport profile is taken by the QoS server 40 as a bandwidth estimate for a particular matching incoming streaming flow.

The above-mentioned processes of: 1) admission control; 2) drop control; 3) traffic classification; and 4) resource estimation, are typically integral with each other. In particular the admission control process occurs first, because absent any admission control, the QoS server 40 would lack any operational information. Additionally, it is typical that the process of traffic classification occurs before the processes of drop control and resource estimation (these two processes can be in any desired order). Alternately, the processes of drop control, traffic classification and resource estimation can occur in any desired order.

The above described methods or processes, including portions thereof, can be performed by software, hardware and combinations thereof. These processes and portions thereof can be performed by computers, computer-type devices, workstations, processors, micro-processors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the present invention have been described, so as to enable one of skill in the art to practice the present invention, the preceding description is intended to be exemplary only. It should not be used to limit the scope of the invention, which should be determined by reference to the following claims.

What is claimed is:

1. A method for controlling streaming in a network comprising:
analyzing at least one Real Time Streaming Protocol (RTSP) message associated with at least one streaming flow; and
controlling Quality of Service (QoS) levels for the at least one streaming flow based on the analyzing of the at least one RTSP message.

2. The method of claim 1, wherein the controlling the Quality of Service levels for the at least one streaming flow includes, admission control.

3. The method of claim 2, wherein the admission control includes at least one decision for allowing the at least one streaming flow to enter the network.

4. The method of claim 2, wherein controlling of the Quality of Service levels for the at least one streaming flow includes classifying the at least one streaming flow based on the data from the analysis of the at least one RTSP message.

5. The method of claim 4, wherein the classification includes categorizing incoming flows of packets of the at least one streaming flow.

6. The method of claim 5, wherein controlling the Quality of Service levels for the at least one streaming flow includes drop control.

7. The method of claim 6, wherein the drop control includes at least one decision for retaining the at least one streaming flow once the at least one streaming flow has entered the network.

8. The method of claim 4, wherein the controlling of the Quality of Service levels for the at least one streaming flow includes resource estimation.

9. The method of claim 8, wherein the resource estimation includes extracting network bandwidth data based on the data from the analysis of the at least one RTSP message.

10. The method of claim 1, wherein the analysis of the at least one RTSP message includes: parsing the at least one RTSP message into at least RTSP and Session Description Protocol (SDP) headers, extracting content from the at least one of the parsed headers and compiling an RTSP transport profile from the at least one the parsed headers.

11. An architecture for controlling streaming in a network comprising:
a first component configured for analyzing at least one Real Time Streaming Protocol (RTSP) message associated with at least one streaming flow; and
a second component configured for controlling Quality of Service (QoS) levels for the at least one streaming flow, based on the analyzed at least one RTSP message.

12. The architecture of claim 11, wherein the first component is additionally configured for intercepting and relaying the at least one RTSP message associated with the at least one streaming flow.

13. The architecture of claim 11, wherein the second component is additionally configured for admission control.

14. The architecture of claim 13, wherein the second component is additionally configured for classifying the at least one streaming flow based on the data from the analysis of the at least one RTSP message.

15. The architecture of claim 14, wherein the second component is additionally configured for drop control.

16. The architecture of claim 14, wherein the second component is additionally configured for resource estimation.

17. The architecture of claim 14, wherein the second component is additionally configured for traffic classification.

18. A computer-usable storage medium having a computer program embodied thereon for causing a suitable programmed system to control streaming in a network by performing the following steps when such program is executed on the system:
analyzing at least one Real Time Streaming Protocol (RTSP) message associated with at least one streaming flow; and
controlling Quality of Service (QoS) levels for the at least one streaming flow based on the analyzing of the at least one RTSP message.

19. The storage medium of claim 18, wherein the controlling the Quality of Service levels for the at least one streaming flow includes, admission control for allowing the at least one streaming flow to enter the network.

20. The storage medium of claim 18, wherein the controlling of the Quality of Service levels for the at least one streaming flow includes classifying the at least one streaming flow based on the data from the analysis of the at least one RTSP message by categorizing incoming flows of packets of the at least one streaming flow.

21. The storage medium of claim 20, wherein controlling the Quality of Service levels for the at least one streaming flow includes drop control.

22. A system for controlling streaming in a network comprising:
a Real Time Streaming Protocol (RTSP) proxy server configured for intercepting and relaying at least one RTSP message and analyzing the at least one RTSP message; and
a second server in communication with the RTSP proxy server, the second server configured for controlling Quality of Service (QoS) levels for at least one streaming flow, based on the analyzing of the at least one RTSP message.

23. The system of claim 22, wherein the RTSP proxy server configured for analyzing the at least one RTSP message includes means for parsing the at least one RTSP message into at least RTSP and Session Description Protocol (SDP) headers, extracting content from at least one of the parsed headers and compiling a bandwidth profile from at least one of the parsed headers.

24. The system of claim 22, wherein the second server includes a Quality of Service (QoS) server.

25. The system of claim 24, wherein the QoS server is configured for controlling QoS levels, and includes components for admission control of the at least one streaming flow.

26. The system of claim 25, wherein the QoS server is configured for controlling QoS levels, and includes components for drop control of the at least one streaming flow.

27. The system of claim 26, wherein the QoS server is configured for controlling QoS levels, and includes components for classifying the at least one streaming flow.

28. The system of claim 27, wherein the QoS server configured for controlling QoS levels, and includes components for allocating bandwidth for the at least one streaming flow.

29. A system for controlling streaming in a network comprising:
means for intercepting at least one Real Time Streaming Protocol (RTSP) message;
means for relaying at least one RTSP message;
means for analyzing for at least one RTSP message; and
means for controlling Quality of Service (QoS) levels for at least one streaming flow associated with the means for analyzing the at least one RTSP message.

30. The system of claim 29, wherein the means for intercepting, means for relaying, and means for analyzing at least one RTSP message includes at least one RTSP proxy server.

31. The system of claim 30, wherein the means for controlling Quality of Service (QoS) levels for at least one streaming flow associated with the analyzed RTSP message include at least one QoS server.

32. The system of claim 31, additionally comprising means for facilitating a control message exchange between the at least one RTSP proxy server and the at least one QoS server

33. The system of claim 32, additionally comprising means for directing at least one RTSP message to at least one RTSP proxy server from at least one QoS server, and means for receiving at least one RTSP message from at least one RTSP proxy server.

34. An apparatus for controlling streaming in a network comprising:
means for obtaining at least one Real time Streaming Protocol (RTSP) message from at least one streaming flow;
means for relaying the at least one RTSP message;
means for analyzing the least one RTSP message; and
means for providing data corresponding to the analysis of the at least one RTSP message to at least one device for controlling Quality of Service (QoS) levels for the at least one streaming flow.

35. The apparatus of claim 34, wherein the means for obtaining the at least one RTSP message from the at least one streaming flow includes means for intercepting the at least one RTSP message.

36. A computer-usable storage medium having a computer program embodied thereon for causing a suitable programmed system to control streaming in a network by performing the following steps when such program is executed on the system:
obtaining at least one Real Time Streaming Protocol (RTSP) message from at least one streaming flow;
relaying the at least one RTSP message;
analyzing the least one RTSP message; and
providing data corresponding to the analysis of the at least one RTSP message to at least one device for controlling Quality of Service (QoS) levels for the at least one streaming flow.

37. The storage medium of claim 36, wherein the obtaining the at least one RTSP message from the at least one streaming flow includes intercepting the at least one RTSP message.
